(19) United States
(12) Patent Application Publication
(10) Pub. No.: US 2002/0090424 A1
(43) Pub. Date: Jul. 11, 2002

(54) Edible molded apparatus with novel effect

(76) Inventor: Kathy L. Runge, Morro Bay, CA (US)

Correspondence Address: KATHY L. RUNGE, 2618 IRONWOOD AVE., MORRO BAY, CA, 93442, US

(21) Appl. No.: 10/074,921

(22) Filed: Feb. 14, 2002

Related U.S. Application Data
(60) Provisional application No. 60/260,776, filed on Jan. 10, 2001.

(51) Int. Cl. A23G 1/00

(52) U.S. Cl. 426/104

(57) ABSTRACT

The “Edible Molded Apparatus with Novel Effect” is designed to provide a decorative, surprising and flavor enhancing experience when placed on an edible preparation, such as on a cake. This apparatus consists of a formed edible body which contains an inner ducting(s) channeling a flowable edible substance out onto an edible preparation. This edible substance provides a novel, surprising effect when propelled through the apparatus and may also enhance flavor of the edible preparation. The apparatus comprises a molded edible body, a ducting which passes through a hole in the edible preparation and it's supporting platform, and connects to a housing for a flowable substance and a propulsion mechanism.

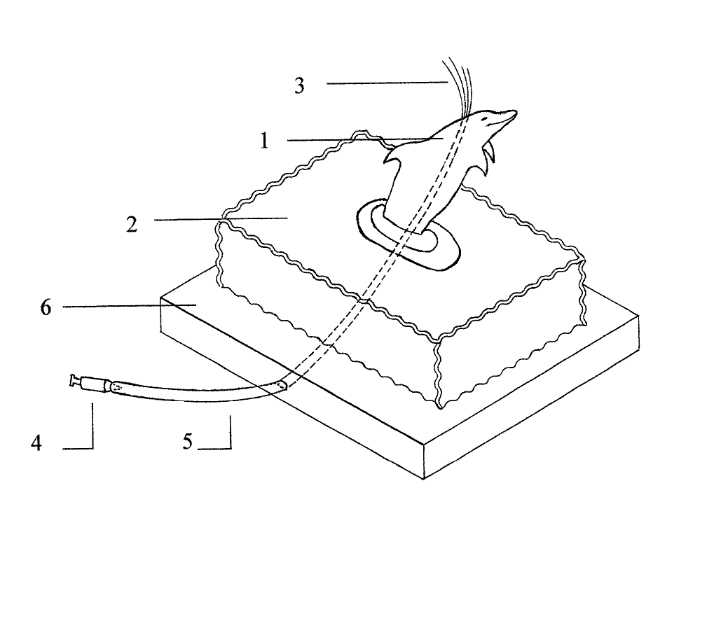

### CROSS-REFERENCE TO RELATED APPLICATIONS

A provisional patent application was filed on Jan. 10, 2001 entitled “Edible molded apparatus with novel effect”. The provisional patent application number is No. 60/260,776.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

Cakes, pastries, fruit cakes, confections, bread loaves, and various other edible items are often decorated for the celebration of birthdays, weddings, holidays, and other special events. These items often are initially presented as a “surprise” and traditionally they may be decorated with any variety of items such as candles, frosting designs, candy, flowers or plastic objects. These edible items often become the centerpieces at special gatherings promoting merriment.

Festive presentations of foods often contain a design theme and a few include a secondary surprising element. Examples of these novel elements may be musical as described in U.S. Pat. No. 3,308,705 issued to R. V. Shinnick., or illuminating as described in U.S. Pat. No. 4,4116,075 issued to Baver. However, most edible presentations are static rather than dynamic. Following the initial presentation of the edible product, most do not include a secondary, novel and surprising visual effect and still fewer provide a flavor enhancement to the edible product.

### BRIEF SUMMARY OF THE INVENTION

This invention is an edible molded apparatus which provides a surprising and novel effect when used in a decorative manner upon another edible product such as cakes, pastries, fruit cakes, confections, bread loaves, and various other edible items. It will be understood that while a decorative cake top is discussed herein, it is only for illustrative purposes.

The invention is a static decorative edible figure which becomes a dynamic decoration when a flowable substance spews through it, thus providing a surprising novel effect. The flowable substance may also provide a flavor enhancement for the total food presentation.

The apparatus is comprised of an edible molded portion and an internal ducting(s) which extends from the outer portion of the molded portion through the base product(s) and into a housing which holds the flowable substance until it is propelled through the ducting(s) and out of the molded apparatus.

### BRIEF DESCRIPTION OF THE SEVERAL VIEWS OF THE DRAWING

The drawing shows an apparatus used as a decorative cake top.

### DETAILED DESCRIPTION OF THE INVENTION

This invention is an edible molded apparatus (1) which sits upon an edible base (2) and channels an edible flowable substance (3) out though the apparatus, thus, providing a surprising and novel artistic effect. The apparatus may be of any shape or size (1). The channel, or channels, may be a molded portion within the apparatus itself and connected to a tubing, or it may consist of another material. The flowable substance is placed in a suitable housing (4) which can be advanced either manually or automatically to flow from the housing out though a tubing and through the apparatus via the ducting(s) (5) at the desired moment. A typical application would consist of a cake (2), supported by an edible or non-edible base (6) such as a cardboard box, and the cake is topped with a molded chocolate figure (1), from which a surprising and flavor enhancing flowable substance is spewed (3) out of the molded figure onto the cake.

What is claimed is:

1. A decorative apparatus providing a novel, surprising and flavor enhancing experience when placed upon and extending through another edible food preparation, supported by an edible or non-edible platform, which comprises:
an edible body formed or molded into a figure;
said body having an inside portion formed to surround ducting(s) which extends from the exterior upper portion of the body to the exterior underside portion of the body;
a housing to store a flowable edible substance;
a ducting(s) comprised of plastic material, which connects to the housing and terminates at the exterior surface(s) of the formed or molded body;
a hole(s) made into the edible food preparation and the platform, through which the ducting passes from the housing to the formed or molded body; and
a manual or automatic propelling mechanism for the flowable substance which attaches to the housing.

2. An apparatus as in claim 1, wherein the ducting(s) within the body is a self-formed channel(s) and,
the plastic ducting connects into the body's self-formed channel(s) providing a passageway for a flowable substance.

3. A device as in claim 1, where the housing is a self contained propulsion mechanism for the flowable substance which omits the need of an additional propulsion device.

4. A decorative apparatus providing a novel, surprising experience when placed upon and extending through another edible food preparation, supported by an edible or non-edible platform, which comprises:
an edible body formed or molded into a figure;
said body having an inside portion formed to surround ducting(s) which extends from the exterior upper portion of the body to the exterior underside portion of the body;
a housing to store a flowable edible substance;
a ducting(s) comprised of plastic material, which connects to the housing and terminates at the exterior surface(s) of the formed or molded body;
a hole(s) made into the edible food preparation and the platform, through which the ducting passes from the housing to the formed or molded body; and
a manual or automatic propelling mechanism for the flowable substance which attaches to the housing.

5. An apparatus as in claim 4, wherein the ducting(s) within the body is a self-formed channel(s) and,
the plastic ducting connects into the body's self-formed channel(s) providing a passageway for a flowable substance.

6. A device as in claim 4, where the housing is a self contained propulsion mechanism for the flowable substance which omits the need of an additional propulsion device.
